(19) United States
(12) Patent Application Publication
(10) Pub. No.: US 2024/0339665 A1
(43) Pub. Date: Oct. 10, 2024

(54) NON-AQUEOUS ALUMINIUM ION SECONDARY BATTERY WITH A QUASI-SOLID ELECTROLYTE AND ELECTROCHEMICALLY ACTIVATED CATHODE MATERIAL WITH HIGH SPECIFIC CAPACITY

(71) Applicant: TECHNISCHE UNIVERSITÄT BERGAKADEMIE FREIBERG, Freiberg (DE)

(72) Inventors: Amir MOHAMMAD, Freiberg (DE); Hartmut STÖCKER, Freiberg (DE); Dirk C. METER, Freiberg (DE)

(73) Assignee: TECHNISCHE UNIVERSITÄT BERGAKADEMIE FREIBERG, Freiberg (DE)

(21) Appl. No.: 18/293,651

(22) PCT Filed: Aug. 12, 2022
(86) PCT No.: PCT/EP2022/072629

§ 371 Date: Jan. 30, 2024

(30) Foreign Application Priority Data
Aug. 13, 2021 (DE) 10 2021 121 129.8

(51) Int. Cl. H01M 10/0568; H01M 10/0567; H01M 10/058

(52) U.S. Cl. CPC H01M 10/0568; H01M 10/0567; H01M 10/058; H01M 2300/0025

(57) ABSTRACT

The invention relates to an aluminum secondary battery comprising at least one positive electrode, at least one negative electrode, at least one electrolyte, and at least one additive, the electrolyte comprising at least one room temperature ionic liquid (RTIL), made of at least one organic salt and at least one first aluminum salt, and/or at least one deep eutectic solvent (DES) made of at least one organic solvent and at least one first aluminum salt, the additive containing bivalent metal cations and/or being suitable for forming bivalent metal cations.

The invention relates to aluminum ion secondary batteries with improved performance and to a method of manufacturing them.

The storage of electrical energy is becoming more and more important with the increasing use of renewable energies. In particular, electrochemical energy storage with rechargeable batteries (secondary batteries) plays a major role.

Up to now, lithium-ion batteries (LIBs) have been the most important energy stores in the prior art. These are characterized by lithium compounds in all three phases of the electrochemical cell; i.e., all reactive materials-anode, cathode and electrolyte-contain lithium ions.

The wide range of applications for LIBs has led in recent years to an enormous increase in the consumption of lithium, with the result that the earth's lithium resources are reaching their limits.

LIBs react disadvantageously to both deep discharge and overcharging with a loss of power, and therefore require special protective circuits.

The search for alternative metals for electrochemical stores is therefore a growing field of current research. Particular importance is accorded here to the metal aluminum.

Aluminum-ion secondary batteries (AIBs), also called aluminum secondary batteries, are secondary batteries which are based on aluminum compounds, aluminum or aluminum compounds being used in particular as anode material.

Due to its trivalence, aluminum has a high specific gravimetric capacity (2980 mAh/g) and the highest volumetric capacity (8046 mAh/cm³).

Since aluminum has three valence electrons, the theoretically possible energy density of AIBs with respect to LIBs is also significantly increased.

Carbon-based cathodes for AIBs are known from the literature, such as graphite [1] or graphene [2]. These cathodes enable reversible intercalation/deintercalation of AlCl₄⁻ complexes during charging/discharging.

The oxides of the transition metals, such as titanium dioxide [3] or vanadium oxide [4], among others, are also used for aluminum ion intercalation.

The makeup of the electrolyte is of great importance in AIBs; the aluminum salt that dissolves during the discharge must dissolve well in the electrolyte, but should not be kept so strongly in solution that aluminum cannot be deposited. The electrolyte must also ensure high ion conductivity and mobility at operating temperature (e.g., room temperature) so that the electrolyte does not contribute to the battery with a high resistance. In addition, the electrolyte has to reversibly coat the negative aluminum electrode without dendrites forming.

Non-aqueous electrolytes have proven to be suitable electrolytes for aluminum deposition.

Non-aqueous electrolytes are, for example, room temperature ionic liquids (RTILs) and deep eutectic solvents (DES). These are known from the prior art.

Ionic liquids are salts whose melting temperature is below 100° C. Ionic liquids are known to those skilled in the art.

Room temperature ionic liquids (RTILs) are a special case of ionic liquids. In these, the formation of a stable crystal lattice is hindered by charge delocalization and steric effects in such a way that they are liquid at room temperature.

A deep eutectic solvent (DES) is a mixture of at least two components that can be solid or liquid independently of each other at room temperature. A combination of the two components in a certain (eutectic) range results in a composition that has such a low melting point that it is liquid at room temperature.

Disadvantageously, the AIBs with non-aqueous electrolytes known from the prior art, in particular with oxidic cathodes, still only have low capacities, low cell voltages, and low cycle stability.

The object of the invention is to overcome the disadvantages of the prior art and to provide an improved AIB with higher efficiency and improved performance characteristics.

The object is achieved by an aluminum secondary battery according to claim 1.

The aluminum secondary battery comprises
at least one positive electrode (referred to hereinafter as cathode),
at least one negative electrode (referred to hereinafter as anode),
at least one electrolyte and
at least one additive,
wherein the electrolyte comprises at least one room temperature liquid ionic liquid (RTIL) made of at least one organic salt and at least one first aluminum salt and/or at least one deep eutectic solvent (DES) made of at least one organic solvent and at least one first aluminum salt,
wherein the additive contains bivalent metal cations and/or is suitable for forming bivalent metal cations.

According to the invention, this is an aluminum secondary battery, hereinafter also referred to as a secondary battery. In the sense of the invention, aluminum secondary battery means that the secondary battery contains aluminum and/or at least one aluminum compound and/or aluminum ions. These can be contained both in at least one of the electrodes and/or the electrolyte.

In embodiments, the secondary battery comprises a housing. Housings for batteries are known from the prior art. In embodiments, the housing is arranged in such a way that it seals the battery cell airtight and allows contacting of the anode and cathode from the outside.

In embodiments, the secondary battery also comprises a separator for separating the anode and cathode compartments. Separators are known from the prior art.

According to the invention, the secondary battery comprises at least one positive electrode, also referred to as cathode. In embodiments, the cathode comprises at least one active material selected from at least one oxidic compound and/or a carbon-based material.

In embodiments, the oxidic compound is selected from TiO₂, AlTiO₅, WO₃, Al₂(WO₄)₃, MoO₂, Al₂(MoO₄)₃ and/or MnO₂.

In embodiments, the cathode comprises a metal and/or a carbon-based or silicon-based material, in particular also as a carrier material, which additionally has the function of conducting the electric current and therefore also acts as a current collector in embodiments. In embodiments, the carbon-based material is selected from graphite and/or graphene.

In embodiments, the silicon-based material is pure silicon.

In embodiments, the cathode comprises at least one carbon-based additive, for example activated carbon. Advantageously, the electronic conductivity is thereby improved.

In embodiments, the carbon-based additive is combined with at least one binder and the at least one active material of the cathode to form an active mixture. In embodiments, the binder is a polymer that is resistant to the corrosive electrolyte, for example polymethyl methacrylate (PMMA), polyether ether ketone (PEEK) or polytetrafluoroethylene (PTFE). In embodiments, the carrier material or the current collector of the positive electrode is coated with the active mixture.

According to the invention, the secondary battery comprises at least one negative electrode, also referred to as anode. In embodiments, the anode comprises aluminum and/or at least one aluminum alloy and/or aluminum ions.

In embodiments, the anode comprises aluminum and/or at least one aluminum alloy in the form of a foil which preferably has a thickness of 1 μm to 2 mm, in particular 10 μm to 100 μm.

According to the invention, the secondary battery comprises at least one electrolyte, wherein the electrolyte comprises at least one room temperature liquid ionic liquid (RTIL) made of at least one organic salt and at least one first aluminum salt and/or at least one deep eutectic solvent (DES) made of at least one organic solvent and at least one first aluminum salt.

In the following, the term “a/an” is always understood to also mean “at least one.” Thus, “an aluminum salt” or “an electrolyte,” etc., also means “at least one aluminum salt” or “at least one electrolyte.”

Ionic liquids that are liquid at room temperature are known to those skilled in the art. These compounds are salts and have a melting point which is below 100° C., and are thus liquid at average room temperature.

In embodiments, the RTILs are produced by a solid state reaction between the first aluminum salt and at least one organic salt. In embodiments, the at least one organic salt is selected from pyridinium chlorides, ammonium chlorides and/or imidazolium chlorides and/or mixtures thereof.

In embodiments, the at least one organic salt is selected from 1-butylpyridinium chloride ([BP]Cl), trimethylphenylammonium chloride (TMPAC), 1-butyl-3-methylimidazolium chloride ([BMIm]Cl), 1-ethyl-3-methylimidazolium chloride ([EMIn]Cl), triethylamine hydrochloride ([Et₃N]HCl), 4-ethylpyridine, 1-butyl-3-methylimidazolium trifluoromethanesulfonate ([BMIm]OTf), pyridinium chloride ([Py]Cl) and/or mixtures thereof.

In embodiments, the first aluminum salt is selected from aluminum halides, for example AlF₃, AlCl₃, AlBr₃, AlI₃, aluminum sulfonates, for example aluminum trifluoromethane sulfonate Al(OTf)₃, aluminum nitrate Al(NO₃)₃, aluminum sulfate Al₂(SO₄)₃, aluminum phosphate AlPO₄, and/or other aluminum salts which can serve as a component of an ionic liquid or eutectic solvent.

In embodiments, the RTIL thus comprises at least one first aluminum salt and at least one organic salt.

In embodiments, the molar ratio of first aluminum salt to organic salt in the RTIL is 1:1 to 2:1, preferably 1.3:1 to 2:1, particularly preferably 1.5:1 to 2:1.

In embodiments, the RTIL is selected from AlCl₃-1-butylpyridinium chloride (AlCl₃-[BP]Cl), AlCl₃-trimethylphenylammonium chloride (AlCl₃-TMPAC), AlCl₃-1-butyl-3-methylimidazolium chloride (AlCl₃-[BMIm]Cl), AlCl₃-1-ethyl-3-methylimidazolium chloride (AlCl₃-[EMIn]Cl), aluminum trifluoromethanesulfonate-1-butyl-3-methylimidazolium trifluoromethane sulfonate (Al(OTf)₃-[BMIm]OTf), AlCl₃-triethylamine hydrochloride (AlCl₃-[Et₃N]HCl), AlCl₃-4-ethylpyridine, AlCl₃ pyridinium chloride (AlCl₃-[Py]Cl) and/or mixtures thereof.

Deep eutectic solvents (Deep Eutectic Solvents-DES) are known to those skilled in the art. In embodiments, the DES is produced by mixing at least the first aluminum salt, for example AlCl₃, and at least one organic solvent selected from pyridines, acetamides or haloalkanes.

In embodiments, the molar ratio of the at least one first aluminum salt to the at least one organic solvent is 1:1 to 2:1, preferably 1.3:1 to 2:1, particularly preferably 1.5:1 to 2:1.

In embodiments, the DES comprises at least one first aluminum salt, for example AlCl₃, and at least one organic solvent selected from pyridines, acetamides or haloalkanes.

In embodiments, the DES is selected from AlCl₃-4-propylpyridine (4-Pr-Py), AlCl₃-acetamide and/or AlCl₃-urea with 1,2-dichloroethane.

In embodiments, the electrolyte comprises only at least one RTIL or only at least one DES. In further embodiments, the electrolyte comprises a mixture of RTIL and DES.

The amount of the first aluminum salt is then calculated on the total amount of RTIL and DES.

In embodiments, the molar ratio between the at least one first aluminum salt and the total amount of organic solvent and/or organic salt is then from 1:1 to 2:1.

In embodiments, the secondary battery comprises at least one, preferably two current collectors.

Current collectors correspond to electron conductors and are known to those skilled in the art.

The anode usually comprises a metal, such as aluminum, which also serves as a current collector.

Typically, the cathode comprises a metallic or carbon-based carrier which is coated with an active material, for example an oxidic compound, in embodiments additionally comprising an additive such as activated carbon, in embodiments the coating thus being with the active mixture. This carrier simultaneously serves as a current collector.

According to the invention, the electrolyte contains at least one additive, wherein the additive contains bivalent metal cations and/or is suitable for forming bivalent metal cations.

Advantageously, the bivalent metal cations catalytically effect an activation of the oxidic material in the cathode of the secondary battery.

In embodiments, the additive is selected from metallic copper and/or at least one copper compound, also referred to as a copper-containing compound.

In embodiments, the at least one additive is contained in the electrolyte, in the anode, in the cathode, and/or in the current collector.

In embodiments, the additive is contained In the electrolyte and is selected from metal particles, In particular copper particles and/or at least one copper compound. In embodiments, the metal particles have a diameter of 0.1 to 50 μm.

In embodiments, the copper compound is selected from CuCl, CuCl₂, CuO, Cu₂O, Cu₂SO₄, CuSO₄ and/or mixtures thereof.

In embodiments, the additive is contained in at least one electrode and is selected from metal particles, in particular copper particles, and/or at least one metal compound, in particular a copper compound, selected from CuCl, CuCl₂, CuO, Cu₂O, CU₂SO₄, CuSO₄ and/or mixtures thereof.

In embodiments, at least one electrode comprises a current collector.

In embodiments, the additive is contained at least in the current conductor.

In embodiments, the current collector is made of the at least one additive.

In embodiments, the current collector comprises at least one coating, wherein at least one first layer contains the at least one additive.

The secondary battery according to the invention advantageously has increased capacitances and cell voltages by the at least one additive.

In embodiments, the at least one additive is thus contained in the electrolyte, in the positive electrode, in the negative electrode and/or in the current collector.

In embodiments, the second aluminum salt is selected from aluminum halides, aluminum sulfonates, aluminum nitrate, aluminum sulfate and/or aluminum phosphate, and/or mixtures thereof.

In embodiments, the second aluminum salt is selected from aluminum halides, for example AlF₃, AlCl₃, AlBr₃, AlI₃, aluminum sulfonates, for example aluminum trifluoromethane sulfonate Al(OTf)₃, aluminum nitrate Al(NO₃)₃, aluminum sulfate Al₂(SO₄)₃, aluminum phosphate AlPO₄, and/or other aluminum salts which can serve as a component of an ionic liquid or eutectic solvent.

In embodiments, the molar ratio between the second aluminum salt and the total amount of (DES and/or RTIL) is from 4:1 to 12:1, preferably 6:1 to 12:1.

In embodiments, the first and second aluminum salt are the same.

In further embodiments, the first and the second aluminum salt are different.

In embodiments, the molar ratio in the quasi-solid electrolyte between the total amount of first and second aluminum salt and the total amount of organic solvent and/or organic salt is 5:1 to 20:1, preferably 7:1 to 12:1.

In embodiments, a total amount of 0.1 to 0.5 ml, preferably 0.2 to 0.4 ml, of the RTIL and/or DES is provided for each gram of the second aluminum salt to prepare the quasi-solid electrolyte.

These are mixed to form a paste. This paste is almost a solid, i.e., is a quasi-solid.

The electrolyte is thus a quasi-solid electrolyte due to the high proportion of salt. Advantageously, the quasi-solid electrolyte has properties of the liquid and solid phase, for example the good ion conductivity of the liquid phase and the stability and immobility of the solid phase. Advantageously, the high density of charge carriers (aluminum cations from the first aluminum salt) brings about an improved capacity and improved cycle stability.

Also advantageously, due to the use of a quasi-solid electrolyte in the secondary battery no separator is required.

Advantageously, a full-surface separator can be dispensed with when using solid electrolytes or quasi-solid electrolytes. This can be replaced, for example in a button cell, by a ring separator. Advantageously, a ring separator prevents contact between the quasi-solid electrolyte and the housing. The quasi-solid electrolyte prevents a short-circuit between the electrodes.

Furthermore, the quasi-solid electrolyte has much less effect on the housing of a secondary battery than liquid electrolytes.

Secondary batteries with quasi-solid electrolytes are also safer, as leakage of the batteries is prevented.

The invention also relates to a method for producing a secondary battery according to the invention, comprising at least the following steps:
a) providing at least one additive which contains bivalent metal cations and/or is suitable for forming bivalent metal cations,
b) providing at least one housing, at least one positive electrode, at least one negative electrode, and at least one electrolyte,
wherein the electrolyte comprises at least one room temperature liquid ionic liquid (RTIL) made of at least one organic salt and at least one first aluminum salt and/or at least one deep eutectic solvent (DES) made of at least one organic solvent and at least one first aluminum salt,
wherein the additive is added to the at least one positive electrode when it is provided and/or wherein the additive is added to the electrolyte when it is provided,
c) assembling the housing, electrodes, and electrolytes to form a secondary battery

Methods for providing a housing are known to those skilled in the art.

Typically, at least one electrode comprises a metallic or carbon-based carrier which can be coated with an active material, for example at least one oxidic compound, in embodiments moreover comprising at least one additive, such as activated carbon, and preferably at least one binder, in embodiments thus being coated with the active mixture. This carrier simultaneously serves as a current collector.

In embodiments, at least one of the electrodes comprises a current collector. Current collectors are known to those skilled in the art. The current collector is part of the electrode and preferably has contact with the electrolyte. In embodiments, the current collector is coated with the active mixture. In embodiments, the current collector conducts the electronic current to the outside, so that the current from the battery can be tapped from the outside, i.e., outside the housing.

According to the invention, at least one additive is provided, wherein the additive contains bivalent metal cations and/or is suitable for forming bivalent metal cations.

In embodiments, the additive is selected from metallic copper and/or at least one copper compound, also referred to as a copper-containing compound.

In embodiments, the at least one additive is contained in the electrolyte, in the anode, in the cathode, and/or in the current collector.

In embodiments, the additive is selected from metal particles, in particular copper particles, and/or at least one copper compound. In embodiments, the metal particles have a diameter of 0.1 to 50 μm.

In embodiments, the copper compound is selected from CuCl, CuCl₂, CuO, CuzO, Cu₂SO₄, CUSO₄ and/or mixtures thereof.

The provision of a positive electrode is done according to the prior art. Methods for providing a positive electrode are known to those skilled in the art.

In embodiments, the positive electrode is produced or is commercially available.

In embodiments, the cathode comprises at least one carbon-based additive, for example activated carbon. Advantageously, the electronic conductivity is thereby improved.

In embodiments, the cathode comprises a carrier material which also functions as a current collector, and is preferably coated with the active mixture of at least one carbon-based additive and at least one binder and at least one active material, for example an oxidic compound. In embodiments, the binder is a polymer that is resistant to the corrosive electrolyte, for example polymethyl methacrylate (PMMA), polyether ether ketone (PEEK) or polytetrafluoroethylene (PTFE).

In embodiments, the positive electrode is produced by mixing the additive with the at least one binder and at least one active material, preferably with a solvent, to form an active mixture, and applying the active mixture to the carrier material of the cathode, for example a metal and/or a carbon-based material. In embodiments, the solvent is subsequently evaporated. Suitable solvents for producing the active mixture described are known to those skilled in the art.

In embodiments, the oxidic compound is selected from TiO₂, AlTiO₅, WO₃, Al₂ (WO₄)₃, MoO₂, Al₂ (MoO₄)₃ and/or MnO₂.

In embodiments, the cathode comprises a carbon-based or silicon-based carrier material. In embodiments, the carbon-based material is selected from graphite and/or graphene.

In embodiments, the silicon-based material is pure silicon.

In embodiments, the additive is added to the positive electrode by adding the additive to the active mixture during the production of the active mixture.

In embodiments, the additive is added to the positive electrode by using the additive as a carrier material of the positive electrode, for example by using a metal sheet or a metal foil, for example copper foil, as a carrier material of the cathode.

In embodiments, the additive is added to the positive electrode by applying a layer of the additive, In particular a metal layer, for example a copper layer, via PVD (physical vapor deposition) and/or CVD (chemical vapor deposition) methods. These methods are known to those skilled in the art. In embodiments, the layer of the additive is applied to the active layer of the positive electrode, In particular after the coating of the support material with the active mixture and subsequent drying.

Methods for providing a negative electrode are known to those skilled in the art.

In embodiments, the negative electrode is provided by manufacturing or by commercially acquiring it.

In embodiments, the anode comprises aluminum and/or at least one aluminum alloy.

In embodiments, the anode comprises aluminum and/or at least one aluminum alloy in the form of a foil which preferably has a thickness of 1 μm to 2 mm, in particular 10 μm to 100 μm.

In embodiments, the anode is produced by removing the native oxide layer from the foil. In embodiments, the foil is cut to fit the secondary battery.

In embodiments, a separator is provided. Methods for providing a separator are known to those skilled in the art. In embodiments, the separator is manufactured by cutting the separator material to fit the secondary battery.

In embodiments, the electrolyte is provided by its manufacture.

In embodiments, the electrolyte is produced in a protective atmosphere.

In embodiments, the electrolyte is produced by mixing an organic salt and/or at least one organic solvent with at least one first aluminum salt.

In embodiments, the electrolyte is prepared by preparing an RTIL, in particular by mixing at least one organic salt and at least one first aluminum salt, or by preparing a DES, in particular by mixing at least one organic solvent and at least one first aluminum salt.

In embodiments, the RTILs are produced by a solid state reaction between the first aluminum salt and at least one organic salt. In embodiments, the at least one organic salt is selected from pyridinium chlorides, ammonium chlorides and/or imidazolium chlorides and/or mixtures thereof.

In embodiments, the at least one organic salt is selected from 1-butylpyridinium chloride ([BP]Cl), trimethylphenylammonium chloride (TMPAC), 1-butyl-3-methylimidazolium chloride ([BMIm]Cl), 1-ethyl-3-methylimidazolium chloride ([EMIn]Cl), triethylamine hydrochloride [Et₃N]HCl, 4-ethylpyridine, 1-butyl-3-methylimidazolium trifluoromethanesulfonate ([BMIm]OTf), pyridinium chloride ([Py]Cl) and/or mixtures thereof.

In embodiments, the first aluminum salt is selected from aluminum halides, for example AlF₃, AlCl₃, AlBr₃, AlI₃, aluminum sulfonates, for example aluminum trifluoromethane sulfonate Al(OTf)₃, aluminum nitrate Al(NO₃)₃, aluminum sulfate Al₂(SO₄)₃, aluminum phosphate AlPO₄, and/or other aluminum salts which can serve as a component of an ionic liquid or eutectic solvent.

In embodiments, the RTIL thus comprises at least one first aluminum salt and at least one organic salt.

In embodiments, the molar ratio of first aluminum salt to organic salt in the RTIL is 1:1 to 2:1, preferably 1.3:1 to 2:1, particularly preferably 1.5:1 to 2:1.

In embodiments, the RTIL is selected from AlCl₃-1-butylpyridinium chloride (AlCl₃-[BP]Cl), AlCl₃-trimethylphenylammonium chloride (AlCl₃-TMPAC), AlCl₃-1-butyl-3-methylimidazolium chloride (AlCl₃-[BMIm]Cl), AlCl₃-1-ethyl-3-methylimidazolium chloride (AlCl₃-[EMIn]Cl), aluminum trifluoromethanesulfonate-1-butyl-3-methylimidazolium trifluoromethane sulfonate (Al(OTf)₃-[BMIm]OTf), AlCl₃-triethylamine hydrochloride (AlCl₃-[Et₃N]HCl), AlCl₃-4-ethylpyridine, AlCl₃ pyridinium chloride (AlCl₃-[Py]Cl) and/or mixtures thereof.

In embodiments, the DES is produced by mixing the at least first aluminum salt, for example AlCl₃, and at least one organic solvent selected from pyridines, acetamides or haloalkanes.

In embodiments, the molar ratio of the at least one first aluminum salt to the at least one organic solvent is 1:1 to 2:1, preferably 1.3:1 to 2:1, particularly preferably 1.5:1 to 2:1.

In embodiments, the DES comprises at least one first aluminum salt, for example AlCl₃, and at least one organic solvent selected from pyridines, acetamides or haloalkanes.

In embodiments, the DES is selected from AlCl₃-4-propylpyridine (4-Pr-Py), AlCl₃-acetamide and/or AlCl₃-urea with 1,2-dichloroethane.

In embodiments, the additive is added to the electrolyte during its provision, in particular during its manufacture.

In embodiments, the additive is added to the electrolyte, i.e., the at least one RTIL and/or DES.

In embodiments, the additive is added by mixing the additive and RTIL and/or DES.

In embodiments, the additive is added to the electrolyte, for example to the RTIL and/or DES, by electrochemical dissolving of a metal, in particular copper, in the RTIL and/or DES. In embodiments, this takes place by charging and discharging. This can be done, for example, by inserting an anode and a metal-containing, in particular copper-containing, cathode into the RTIL and/or DES and applying a current between the two electrodes, wherein metal ions, in particular copper ions, detach from the cathode and pass into the RTIL and/or DES. In embodiments, the current density is 0.1 to 10 mA/cm².

In embodiments, a current is applied until a voltage of 1 to 5 V, preferably 2 to 3 V, is reached between the electrodes.

In embodiments, the process is repeated with the current direction reversed.

In embodiments, the additive is added to the electrolyte by adding at least one copper compound to the RTIL and/or DES.

In embodiments, the additive is contained in the positive electrode. In embodiments, the positive electrode comprises a current collector containing the at least one additive.

In embodiments, the current collector is a metal that is suitable for emitting bivalent metal cations, for example copper.

In embodiments, the additive is added to the positive electrode by adding the additive, for example a copper compound and/or copper particles, to the additive mixture applied to the positive electrode.

In embodiments, the additive is not added to the RTIL and/or DES until commissioning of the secondary battery.

In embodiments, the electrolyte is produced by mixing the RTIL and/or DES with at least one second aluminum salt to obtain a quasi-solid electrolyte.

In embodiments, the molar ratio between the second aluminum salt and the total amount of (DES and/or RTIL) is from 4:1 to 12:1, preferably 6:1 to 12:1.

In embodiments, the first and second aluminum salt are the same.

In further embodiments, the first and the second aluminum salt are different.

In embodiments, the molar ratio in the electrolyte between the total amount of first and second aluminum salt and the total amount of organic solvent and/or organic salt is 5:1 to 20:1, preferably 7:1 to 12:1.

In embodiments, a total amount of 0.1 to 0.5 ml, preferably 0.2 to 0.4 ml, of the RTIL and/or DES is provided for each gram of the second aluminum salt to prepare the quasi-solid electrolyte.

In embodiments, these are mixed to form a paste. This paste is almost a solid, i.e., is a quasi-solid. The electrolyte is then a quasi-solid electrolyte.

In embodiments, when the electrolyte is a quasi-solid electrolyte, the addition of the additive to the electrolyte takes place analogously to the addition of the additive to the RTIL and/or DES.

In embodiments, the additive is contained in at least one electrode and is selected from metal particles, in particular copper particles, and/or at least one metal compound, in particular a copper compound, selected from CuCl, CuCl₂, CuO, Cu₂O, CU₂SO₄, CuSO₄ and/or mixtures thereof.

The subject matter of the invention is also the use of the aluminum secondary battery according to the invention and/or of the method according to the invention for producing an aluminum secondary battery for energy stores and/or energy storage systems.

The subject matter of the invention is also the use of copper and/or at least one copper compound as an additive, contained in electrolyte, electrode or current collector, for example in the secondary batteries according to the invention.

In order to implement the invention, it is also expedient to combine the above-described embodiments and features of the claims. The invention is not limited to the illustrated and described embodiments, but also includes all embodiments which act identically within the meaning of the invention. Furthermore, the invention is also not limited to the specifically described feature combinations, but may also be defined by any other combination of particular features of all individual features disclosed overall, provided the individual features are not mutually exclusive, or a specific combination of individual features is not explicitly excluded.

The following exemplary embodiments are intended to explain the invention in more detail without, however, having a limiting effect:

In the Figures:

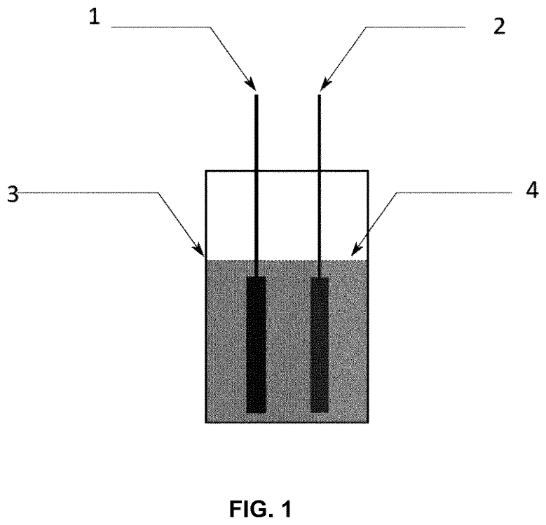

FIG. 1 shows the schematic structure of a secondary battery.

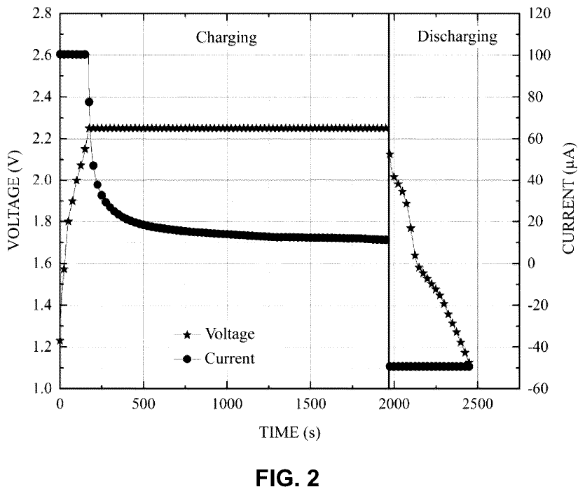

FIG. 2 shows the charge-discharge curves of a cathode whose active material Al₂ (WO₄)₃ was applied to a molybdenum foil together with activated carbon and PMMA binder in a mass ratio of 80% active material, 10% binder, 10% activated carbon. As electrolyte, the RTIL [EMIm]CI/AlCl₃ was used. The ratio of AlCl₃ to [EMIn]CI in the RTIL was 1.3:1. An aluminum foil was used as the anode.

Although the drawn discharge current of −50 μA is very low, the discharge time of 500 s is very short and the curve shows two slight discharge plateaus.

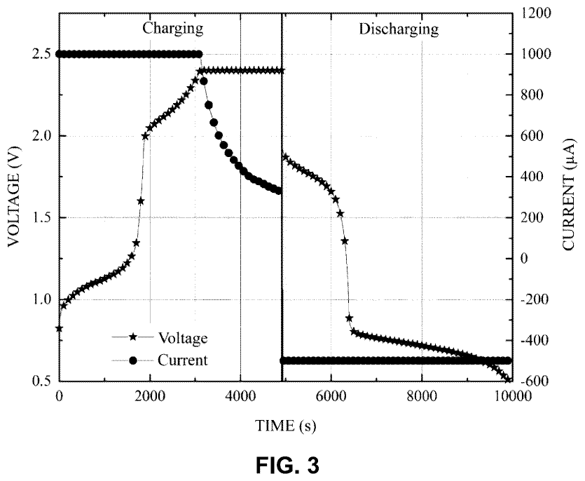

FIG. 3 shows the charge-discharge behavior of a comparable amount of the active material Al₂(WO₄)₃ together with activated carbon and PMMA binder in a mass ratio of 80% active material, 10% binder, 10% activated carbon, in the presence of copper. Metallic copper was used as a current collector for this purpose. Through cycling, i.e., charging and discharging, of the cell, copper ions detach from the copper current collector and are present in the electrolyte. Despite the higher discharge current of −500 μA, a clear discharge plateau can be seen at 1.8 V. The discharge time is 1500 s, which is a substantial improvement compared to the cell of FIG. 2. The second discharge plateau at about 0.7 V is attributable to the metallic copper of the current collector.

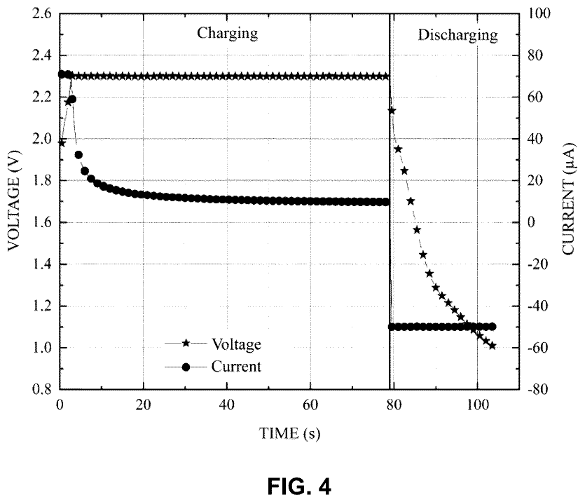

FIG. 4 shows the charge-discharge curves of a cathode whose active material TiO₂ was deposited on a molybdenum foil together with activated carbon and PMMA binder in a mass ratio of 80% active material, 10% binder, 10% activated carbon. The electrolyte used was the ionic liquid [EMIm]CI/AlCl₃ used. The ratio of AlCl₃ to [EMIm]CI was 1.3:1. An aluminum foil was used as the anode.

The cell already reaches its nominal voltage when a low charging current of 70 μA is applied. This indicates a very low, negligible charging capacity. Even when discharging with a low current of −50 μA, the cell does not show a clear discharge plateau and the cell voltage decreases sharply within a few seconds.

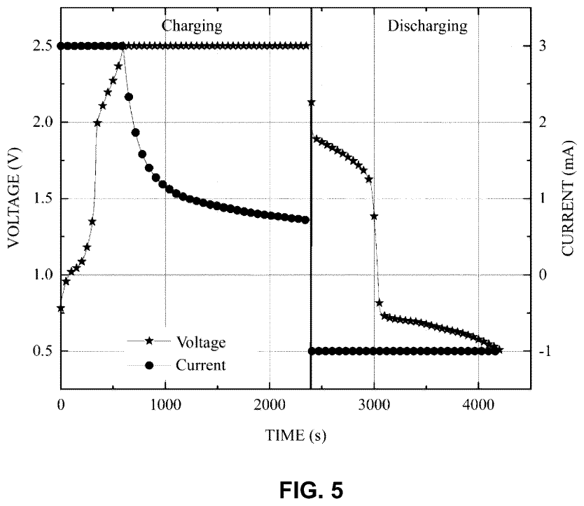

FIG. 5 shows the charge-discharge behavior of a comparable amount of the active material as in FIG. 4 in the presence of copper. Copper was used as a current collector for this purpose. Despite the higher discharge current of −1 mA, a clear discharge plateau can be observed at 1.8 V. The discharge time is 600 s.

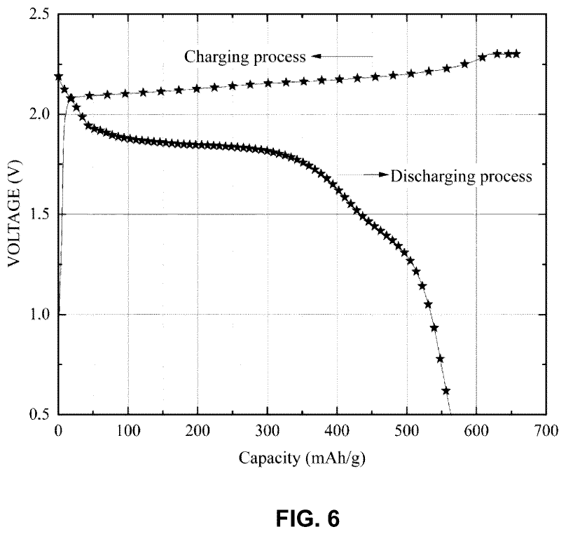

FIG. 6 shows the measurement of the solid-state battery in a button cell. The cathode TiO₂ was applied to a pressed graphite foil together with activated carbon and PMMA binder. The electrolyte used was a paste of AlCl₃ and a small amount of the ionic liquid AlCl₃-[EMIm]CI. A Cu foil was cycled therein.

An aluminum foil was used as the anode. If the cell capacity is related to the cathode material, a very high specific capacity of over 500 mAh/g, comparable to lithium cathodes, and a stable discharge voltage of around 1.8 V are obtained. Furthermore, the figure shows that the low discharge plateau is not present, which indicates a complete conversion of metallic copper into dissolved copper.

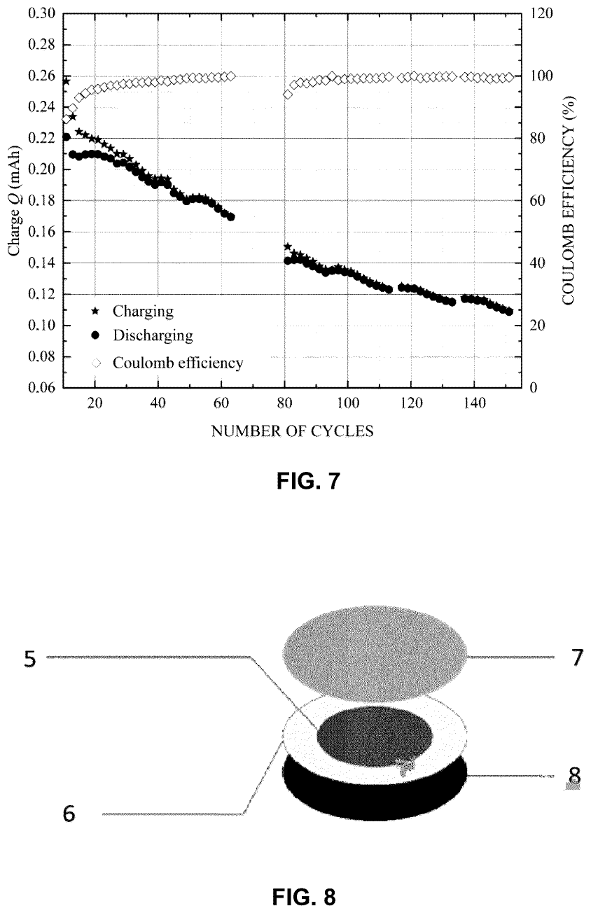

FIG. 7 shows the cycle stability of a glass cell whose active material TiO₂ was applied to a molybdenum foil together with activated carbon and PMMA binder. An aluminum foil was used as the anode, and a paste of AlCl₃ and a small amount of the ionic liquid AlCl₃-[EMIm]CI was used as the solid electrolyte. Before the cell construction, in the solid electrolyte a copper foil was cycled against aluminum in order to enable the formation of the copper compound (dissolved Cu ions) in the electrolyte.

After 150 cycles, the cell shows 50% of the initial capacity. This capacity decrease can be attributed to the degradation of the binder PMMA in the cathode. The Coulomb efficiency of the cell is very high (>95%), i.e., only a small portion of the charge is lost.

FIG. 8 shows the components of the button cell of the exemplary embodiment 2.

### EXEMPLARY EMBODIMENTS

### Example 1 (Glass Cell Liquid Electrolyte System)

### Preparation of the Negative Electrode (Anode):

A pure aluminum foil is sanded with sandpaper inside the argon-filled glovebox to remove the native oxide layer. The removed particles are then removed using a dry cloth. A 0.6 cm wide strip 5 cm long, which will be used as the anode, is cut from the foil.

### Preparation of the Liquid Electrolyte:

The electrolyte is produced in the argon-filled glovebox in the absence of water vapor and oxygen.

A room temperature ionic liquid (RTIL) is produced by a solid state reaction of the organic salt 1-ethyl-3-methylimidazolium chloride [EMIm]CI with the aluminum salt AlCl₃. The molar ratio AlCl₃: [EMIm]CI here is 1.3:1.

### Preparation of the Positive Electrode (Cathode):

The cathode is produced under atmosphere.

0.1 grams of a binder resistant in the electrolyte, e.g., polymethyl methacrylate (PMMA), are dissolved in 5 mL of acetone. To this are added 0.8 grams of active material, e.g. Al₂(WO₄)₃, and 0.1 grams of activated carbon. A homogeneous slurry is produced by mixing the components.

A 0.6 cm wide strip of length 5 cm is cut from a copper foil. This will simultaneously be used as a current collector for the cathode and as an ion source for Cu ions.

The strip is immersed in the slurry to a depth of about 2 cm. A slurry layer is thus applied onto the surface, which is dried and then used as cathode.

### Structure of the Battery:

The battery is built in an argon-filled glovebox. The electrolyte is filled into a glass container and sealed with a lid, in which the electrodes are inserted via a septum.

### Characterization of the Battery:

The electrodes of the battery are connected to a battery cycler or potentiostat. The charge/discharge cycles are controlled in such a way that a fixed current of 1.0 mA is applied until a maximum voltage of 2.35 V is reached during charging. During the discharging, a fixed current of −0.5 mA is drawn in the opposite direction until a minimum voltage of 0.5 V is reached. The measurement result is shown in FIG. 3.

### Example 2 (Button Cell with Quasi-Solid Electrolyte System)

### Preparation of the Negative Electrode (Anode):

A pure aluminum foil is sanded with sandpaper inside the argon-filled glovebox in the absence of water vapor and oxygen, to remove the native oxide layer. The removed particles are then removed using a dry cloth. A round disk of diameter 16 mm is punched out of the foil, which disk will be used as anode.

### Preparation of the Separator:

A glass nonwoven ring is used as separator. For this purpose, a ring having inner diameter 10 mm and external diameter 16 mm is punched out of a thin glass nonwoven foil.

### Preparation of the Electrolyte:

The electrolyte is also produced in the argon-filled glovebox.

First, a room temperature ionic liquid (RTIL) is produced by a solid state reaction of the organic salt 1-ethyl-3-methylimidazolium chloride [EMIm]CI with the aluminum salt AlCl₃. The molar ratio AlCl₃: [EMIm]CI here is 1.3:1.

0.3 mL is removed from this ionic liquid and added to one gram AlCl₃. Mixing these two components in a beaker produces a homogeneous paste of the aluminum salt, which will be used as a quasi-solid electrolyte after the addition of copper ions.

An aluminum strip (negative electrode) and a copper strip (positive electrode) are inserted into the electrolyte. A current of 1.5 mA is applied for 3 hours until a voltage of 2.35 V is reached. A current of −1 mA is then applied until a voltage of 0.4 V has been reached. This process is repeated twice. In this way, electrically dissolved Cu ions enter into the electrolyte.

### Preparation of the Positive Electrode (Cathode):

The cathode is produced under atmosphere. 0.1 grams of a binder resistant in the electrolyte, e.g., polymethyl methacrylate (PMMA), are dissolved in 5 mL solvent, e.g., acetone. To this are added 0.8 grams of active material, e.g. TiO₂, and 0.1 grams of activated carbon. A homogeneous slurry is produced by mixing the components. This is applied to a graphite foil (current collector) using a doctor blade and then dried in air. A disk of diameter 16 mm is punched out of the coated foil, which disk will be used as cathode.

### Structure of the Battery:

The battery is constructed inside the argon-filled glovebox. For this purpose, the separator ring is placed centrally on the anode. Approximately 0.1 gram of the produced quasi-solid electrolyte is placed on the center of the anode disc and distributed homogeneously with a glass rod. The cathode is then placed on top and the stack (see FIG. 8) is then sealed in a button cell.

### Characterization of the Battery:

The electrodes of the battery are connected to a battery cycler or potentiostat. The charge/discharge cycles are controlled in such a way that a fixed current of 0.3 mA is applied until a maximum voltage of 2.35 V is reached during charging. During the discharging, a fixed current of −0.2 mA is drawn in the opposite direction until a minimum voltage of 0.5 V is reached. The measurement result is shown in FIG. 6.

### CITED NON-PATENT LITERATURE

[1] M.-C. Lin, M. Gong, B. Lu, Y. Wu, D.-Y. Wang, M. Guan, M. Angell, C. Chen, J. Yang, B.-J. Hwang, H. Dai: An Ultrafast Rechargeable Aluminium-Ion Battery, Nature 520, 324 (2015)
[2] H. Chen, F. Guo, Y. Liu, T. Huang, B. Zheng, N. Ananth, Z. Xu, W. Gao, C. Gao: A Defect-Free Principle for Advanced Graphene Cathode of Aluminum-Ion Battery, Advanced Materials 29, 1605958 (2017)
[3] S. Liu, J. J. Hu, N. F. Yan, G. L. Pan, G. R. Li, X. P. Gao: Aluminum Storage Behavior of Anatase TiO₂ Nanotube Arrays in Aqueous Solution for Aluminum Ion Batteries, Energy and Environmental Science 5, 9743 (2012)
[4] Y. Ru, S. Zheng, H. Xue, H. Pang: Different Positive Electrode Materials in Organic and Aqueous Systems for Aluminium Ion Batteries, Journal of Materials Chemistry A 7, 14391 (2019)
[5] T. Jiang, M. J. Chollier Brym, G. Dubé, A. Lasia, G. M. Brisard: Electrodeposition of Aluminium from lonic Liquids: Part I—Electrodeposition and Surface Morphology of Aluminium from Aluminium Chloride (AlCl₃)-1-Ethyl-3-Methylimidazolium Chloride ([EMIm]CI) Ionic Liquids, Surface and Coatings Technology 201, 1 (2006)
[6] M. H. Chakrabarti, F. S. Mjalli, I. M. AlNashef, Mohd. A. Hash, Mohd. A. Hussain, L. Bahadori, C. T. J. Low: Prospects of Applying Ionic Liquids and Deep Eutectic Solvents for Renewable Energy Storage by Means of Redox Flow Batteries, Renewable and Sustainable Energy Reviews 30, 254 (2014)
[7] L. Suo, Y. S. Hu, H. Li, M. Armand, L. Chen: A new class of Solvent-in-Salt electrolyte for high-energy rechargeable metallic lithium batteries, Nature Communications 4, 1481 (2013)

### LIST OF REFERENCE SIGNS

1 Cathode
2 Anode
3 Glass housing
4 Electrolyte
5 Quasi-solid electrolyte
6 Separator ring
7 Anode of the button cell
8 Cathode of the button cell

1. An aluminum secondary battery, comprising:
at least one positive electrode,
at least one negative electrode,
at least one electrolyte and
at least one additive,
wherein the electrolyte comprises at least one room temperature liquid ionic liquid (RTIL) made of at least one organic salt and at least one first aluminum salt and/or at least one deep eutectic solvent (DES) made of at least one organic solvent and at least one first aluminum salt,
wherein the additive contains bivalent metal cations and/or is suitable for forming bivalent metal cations.

2. The aluminum secondary battery according to claim 1, wherein the first aluminum salt is selected from aluminum halides, aluminum sulfonates, aluminum nitrate, aluminum sulfate, and/or aluminum phosphate, and/or mixtures thereof.

3. The aluminum secondary battery according to claim 1, wherein the at least one organic salt is selected from 1-butylpyridinium chloride ([BP]Cl), trimethylphenylammonium chloride (TMPAC), 1-butyl-3-methylimidazolium chloride ([BMIm]Cl), 1-ethyl-3-methylimidazolium chloride ([EMIn]Cl), triethylamine hydrochloride ([Et₃N]HCl), 4-ethylpyridine, 1-butyl-3-methylimidazolium trifluoromethanesulfonate ([BMIm]OTF), pyridinium chloride ([Py]Cl) and/or mixtures thereof.

4. The aluminum secondary battery according to claim 1, wherein the molar ratio between the at least one first aluminum salt and the total amount of organic solvent and/or organic salt is 1:1 to 2:1.

5. The aluminum secondary battery according to claim 1, wherein the additive is selected from copper and/or a copper compound and/or mixtures thereof.

6. The aluminum secondary battery according to claim 1, wherein the battery additionally comprises at least one current collector.

7. The aluminum secondary battery according to claim 6, wherein the additive is contained in the electrolyte, in the positive electrode, in the negative electrode, and/or in the current collector.

8. The aluminum secondary battery according to claim 1, wherein the electrolyte additionally comprises a second aluminum salt, wherein the molar ratio between the total amount of first and second aluminum salt and the total amount of organic solvent and/or organic salt is 5:1 to 20:1.

9. The aluminum secondary battery according to claim 8, wherein the second aluminum salt is the same as or different from the first aluminum salt, and wherein the second aluminum salt is selected from aluminum halides, aluminum sulfonates, aluminum nitrate, aluminum sulfate, and/or aluminum phosphate, and/or mixtures thereof.

10. The aluminum secondary battery according to claim 1, wherein the negative electrode comprises aluminum and/or an aluminum alloy.

11. A method for producing an aluminum secondary battery, comprising at least the following steps:
a) providing at least one additive which contains bivalent metal cations and/or is suitable for forming bivalent metal cations,
b) providing at least one housing, at least one positive electrode, at least one negative electrode, and at least one electrolyte,
wherein the electrolyte comprises at least one room temperature liquid ionic liquid (RTIL) made of at least one organic salt and at least one first aluminum salt and/or at least one deep eutectic solvent (DES) made of at least one organic solvent and at least one first aluminum salt,
wherein the additive is added to the at least one positive electrode when it is provided and/or wherein the additive is added to the electrolyte when it is provided,
c) assembling the housing, electrodes, and electrolytes to form an aluminum secondary battery.

12. The method according to claim 11, wherein the RTIL is selected from AlCl₃-1-butylpyridinium chloride (AlCl₃-[BP]Cl), AlCl₃-trimethylphenylammonium chloride (AlCl₃-TMPAC), AlCl₃-1-butyl-3-methylimidazolium chloride (AlCl₃-[BMIm]Cl), AlCl₃-1-ethyl-3-methylimidazolium chloride (AlCl₃-[EMIn]Cl), aluminum trifluoromethanesulfonate-1-butyl-3-methylimidazolium trifluoromethane sulfonate (Al(OTF))₃-[BMIm]OTF), AlCl₃-triethylamine hydrochloride (AlCl₃-[Et₃N]HCl), AlCl₃-4-ethylpyridine, AlCl₃-pyridinium chloride (AlCl₃-[Py]Cl) and/or mixtures thereof, and wherein the DES is selected from AlCl₃-4-propylpyridine (4-Pr-Py), AlCl₃-acetamide and/or AlCl₃-urea with 1,2-dichloroethane.

13. The method according to claim 11, wherein the electrolyte is produced by mixing the RTIL and/or the DES with at least one second aluminum salt to obtain a quasi-solid electrolyte.

14. The method according claim 11, wherein the additive is added to the electrolyte by electrochemical dissolving of a metal, in particular copper, in the RTIL and/or DES or the quasi-solid electrolyte or by mixing additive and RTIL and/or DES or quasi-solid electrolytes.

15. An energy stores and/or energy storage systems comprising an aluminum secondary battery according to claim 1.

16. An aluminum secondary battery comprising: an electrolyte containing copper and/or a copper compound as an additive; an electrode containing copper and/or a copper compound as an additive; or a current collector containing copper and/or a copper compound as an additive.

17. The aluminum secondary battery according to claim 2, wherein the at least one organic salt is selected from 1-butylpyridinium chloride ([BP]Cl),
trimethylphenylammonium chloride (TMPAC), 1-butyl-3-methylimidazolium chloride ([BMIm]Cl), 1-ethyl-3-methylimidazolium chloride ([EMIn]Cl), triethylamine hydrochloride ([Et₃N]HCl), 4-ethylpyridine, 1-butyl-3-methylimidazolium trifluoromethanesulfonate ([BMIm]OTF), pyridinium chloride ([Py]Cl) and/or mixtures thereof.

18. The aluminum secondary battery according to claim 17, wherein the molar ratio between the at least one first aluminum salt and the total amount of organic solvent and/or organic salt is 1:1 to 2:1.

19. The aluminum secondary battery according to claim 18, wherein the additive is selected from copper and/or a copper compound and/or mixtures thereof.

20. The aluminum secondary battery according to claim 19, wherein:
the battery additionally comprises at least one current collector;
the additive is contained in the electrolyte, in the positive electrode, in the negative electrode, and/or in the current collector;
the electrolyte additionally comprises a second aluminum salt, wherein the molar ratio between the total amount of first and second aluminum salt and the total amount of organic solvent and/or organic salt is 5:1 to 20:1;
the second aluminum salt is the same as or different from the first aluminum salt, and wherein the second aluminum salt is selected from aluminum halides, aluminum sulfonates, aluminum nitrate, aluminum sulfate, and/or aluminum phosphate, and/or mixtures thereof; and
the negative electrode comprises aluminum and/or an aluminum alloy.
